(19) United States
(12) Patent Application Publication
(10) Pub. No.: US 2019/0379948 A1
(43) Pub. Date: Dec. 12, 2019

(54) VICINITY GENERATED ADVERTISEMENTS WITH ZONE BASED TRACKING OF 3D OBJECTS IN A 3D ENVIROMENT

(71) Applicant: Lewis McClam, Tampa, FL (US)

(72) Inventor: Lewis McClam, Tampa, FL (US)

(21) Appl. No.: 16/006,108

(22) Filed: Jun. 12, 2018

(51) Int. Cl. H04N 21/81; G06T 19/00; G06T 17/00

(52) U.S. Cl. CPC H04N 21/812; G06T 2219/004; G06T 17/00; G06T 19/006

(57) ABSTRACT

A zoned 3D object is created for an intended 3D environment. Computer code is injected into the object. Computer code utilizes plugin file in the application. The object initiates a program that checks for users in a specified vicinity. Once a threshold is met program begins zone-based tracking. Program then submits media request for advertisement material to cloud server including application ID, user profile, device specifications. Cloud server delivers requested advertisements to plugin in application. Advertisements are displayed on zoned 3D object. Zone tracking measures user interaction via various inputs methods across all zones visible on zoned 3D object to all users in the 3D environment. All tracking data is sent to cloud server for processing.

Advertising in some instances has become the only means of income for some application types. Advertisers may not choose to place their media in some applications due to possible lack of interested users, and prohibitive cost. Additionally, many users may feel that advertisers do not accurately calculate their desired interest in advertisements shown. Most current advertisements focus on placement as the primary concern. But our world is now much more dynamic and requires a more succinct system to deliver and track user interactions. Using an updated system would allow the quick targeted advertisements where the application developer would prefer the user to interact. While gathering detailed information to ensure advertisers tailor their campaigns to the user profiles strategically. While other advertisement platforms can provide 2D advertisements in various applications dynamically. They cannot place that same content organically in a 3D environment based on user vicinity. Tracking the user view of that advertisement in the 3D environment down to what portion of the advertisement that gathered the most attention is not currently being utilized. This situation is an ideal opportunity to generate a more accurate representation of advertisement needs in our current dynamic world.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Embodiments of the present invention relate to employing a means to deliver and track advertisements on 3D models in a 3D environment. In some embodiments, an advertisement in the 3D environment may be loaded based on the user's vicinity in the 3D environment. The application user's advertisement delivery may be changed based on user profile, device specifications, or advertiser targeting to customize the advertising message to the user in the 3D environment. In further embodiments, the user may be provided a service that removes or replaces advertisements from the 3D environment from the user's view. This may be, for instance, a lee-based or other membership-based service provided to the user by the application developer or designated advertisement system. In such embodiments, when an zoned 3D object in the 3D environment is within a specified vicinity of said user advertisement will not be loaded or to replace the content or the advertisement with non-advertising content.

### BRIEF DESCRIPTION OF THE DRAWINGS

The present invention is described in detail below with reference to the attached drawing figures, wherein:

FIG. 1 is a block diagram or an exemplary computing environment suitable for use in implementing embodiments or the present invention;

FIG. 2 is a flow diagram showing a method for providing advertisements with a code injected 3d asset in a 3d environment based on user vicinity in accordance with an embodiment of the present invention;

FIG. 3 is a flow diagram showing a zone tracking analytics system to measure time, location, and profile of user interaction of zoned 3D object in a 3d environment with an embodiment of the present invention;

FIG. 4 is a flow diagram showing a method for loading a modified advertisement to personalize the advertisement in accordance with an embodiment of the present invention;

FIG. 5 is a flow diagram showing a method for removing an advertisement in accordance with an embodiment of the present invention.

### DETAILED DESCRIPTION

The subject matter of the present invention is described with specificity herein to meet statutory requirements. However, the description itself is not intended to limit the scope of this patent.

Rather, the inventor has contemplated that the claimed subject matter might also be embodied in other ways, to include different steps or combinations of steps similar to the ones described in this document, in conjunction with other present or future technologies.

Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention are directed to providing vicinity based targeted advertising and other information via a zoned 3D object in a 3D environment. In accordance with some embodiments, an advertising system for a zoned 3D object in a 3D environment may target information based on parameters indicative of the zoned 3D object users most recent interests and other factors from the zoned 3D object user's current environment.

The system may attempt to determine what the zoned 3D object user may be most recently interested in to target advertisements.

The 3D object in a 3D environment user's gaze may be tracked to determine the 3D object in a 3D environment user's focus. The zoned 3D object user's gaze will be tracked to determine the zone on the zoned 3D object in a 3D environment the user is focused on.

Surrounding data may be faded out and focus placed on the 3D object in a 3D environment user's focal point to collect data points for advertisement selection. The 3D object in a 3D environment user's length of gaze may also be tracked. The longer an 3D object in a 3D environment user gazes at a particular subject (person, place, thing), the stronger the data point becomes. The zoned 3D object user's length of gaze may also be tracked. The longer a zone is viewed the more targeted the following objects advertisement will be.

In some embodiments, the zoned 3D object in a 3D environment user may be looking at a in game user 3D avatar, advertisements would display on that particular person.

The system may identify the person and bring in information about the person, which in some embodiments may be used in advertisement targeting.

In further embodiments, the system may use information about the gaze of multiple users with singular or multiple zoned 3D object in the 3D environment advertisement targeting.

In particular, if multiple people in the 3D object in a 3D environment user's vicinity are looking at a particular subject, it's likely that the subject is interesting or important for some reason. In some embodiments, an 3D object in a 3D environment user's view or an existing advertisement (e.g., a billboard) may be augmented by the 3D object in a 3D environment.

In some instance, the advertisement may be personalized using the to augment the zoned 3D object user's view to deliver a more targeted advertisement. The advertisement may have a generic message for people who are not using the same devices to view the zoned 3D object in the 3D environment. For people using the same device to view the zoned 3D object in the 3D environment, the view of the advertisement may be changed to personalize the advertisement. This may include loading different versions of the same advertisement or re-skinning the entire advertisement with a personalized message.

One way an advertisement may be personalized would be placing an image of the user, the user's family, and/or the user's friends in the context of the advertisement.

In still further embodiments of the present invention, a zoned 3D object user may be provided the option to have advertisements removed from the 3D environment users view or replaced with other content.

In some embodiments, the advertisements may be simply removed. In other embodiments, the advertisements may be replaced with the zoned 3D object in a 3D environment user's own content or other non-advertising content. For instance, an advertisement on a billboard could be replaced with a picture of the user's family or friends from social media.

Accordingly, in one aspect, an embodiment of the present invention is directed to one or more computer-storage media storing computer-useable instructions that, when used by one or more computing devices, cause the one or more computing devices to perform a method for the application device to display a zoned 3D object in a 3D environment-based user's vicinity to the object.

The method includes identifying the zoned object within the 3D environment user's vicinity. The method also includes causing the zoned 3D object in a 3D environment to provide a different advertisement that is personalized to the zoned 3D object user based on content of the advertisement and a user profile for the zoned 3D object user.

In another embodiment, an aspect of the invention is directed to one or more computer-storage media storing computer-useable instructions that, when used by one or more computing devices, cause the one or more computing devices to perform a method for a zoned 3D object in a 3D environment to display non-advertising content. The method includes identifying the zoned 3D object in vicinity and performing a server check for an advertising block by application or advertisement network provider. The method also includes displaying a computer-generated modified virtual image within the zoned 3D object user's field of view to replace the advertisement with non-advertising content.

A further embodiment of the invention is directed to a method performed by a zoned 3D object in a 3D environment device to remove an advertisement from a zoned 3D object user's augmented virtual view of the real world.

The method includes identifying the advertisement on a zoned 3D object user's vicinity in a 3D environment. The method further includes causing the zoned 3D object in a 3D environment to display a computer-generated virtual image to remove the advertisement from the zoned 3D object user's augmented virtual view of the real world.

Having briefly described an overview of embodiments of the present invention, an exemplary operating environment in which embodiments or the present invention may be implemented is described below in order to provide a general context for various aspects or the present invention.

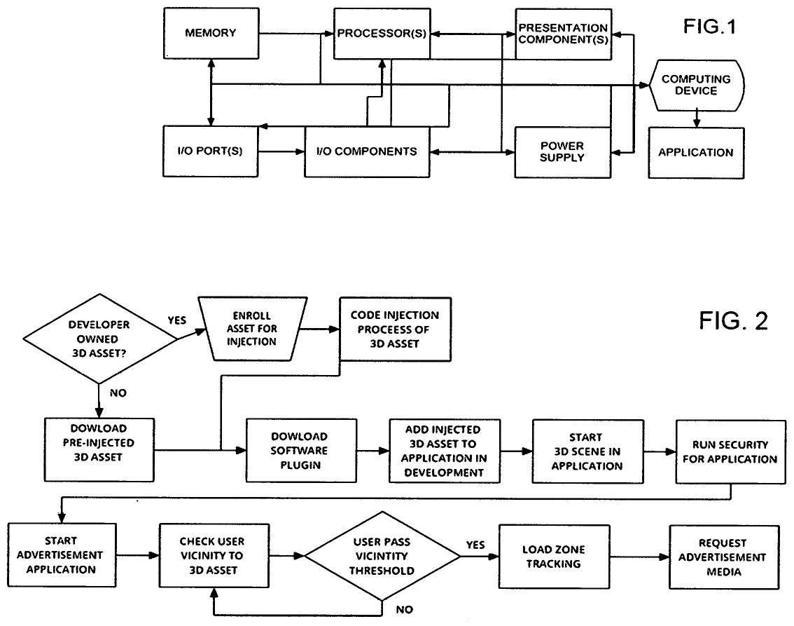

Referring initially to FIG. 1, an exemplary operating environment for implementing embodiments or the present invention is shown and designated generally as computing device.

Computing device is but one example of a suitable computing environment and is not intended to suggest any limitation as to the scope of use or limitations/legitimacy of the invention. Neither should the computing device be interpreted as having any dependency or requirement relating to any on or combination of components illustrated.

The invention may be described in the general context or computer code or machine-useable instructions, including computer-executable instructions such as program modules, being executed by a computer or other machine, such as a personal data assistant or other handheld device.

Generally, program modules including routines, programs, objects, components, data structures, etc., refer to code that perform particular tasks or implement particular abstract data types.

The invention may be practiced in a variety of system configurations, including hand-held devices, consumer electronics, general-purpose computers, more specially computing devices, etc. The invention may also be practiced in distributed computing environments where tasks are performed by remote-processing devices that are linked through a communications network.

With reference to FIG. 1, computing device includes a bus that directly or indirectly couples the following devices: memory, one or more processors, one or more presentation components, input/output (I/O) ports, input/output components, and an illustrative power supply. Bus represents what may be one or more busses (such as an address bus, data bus, or combination thereof).

Although the various blocks of FIG. 1 are shown with arrows for the sake of clarity, in reality, delineating various components is not so clear, and metaphorically, the lines would more accurately many arrows from devices to all devices. For example, one may consider a presentation component such as a display device to be an I/O component. Also, processors have memory.

The inventor recognize that such is the nature of the art and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

Computing device in FIG. 1 typically includes a variety of computer-readable media. Computer-readable media can be any available media that can be accessed by computing device and includes both volatile and nonvolatile media, removable and non-removable media. By way of example, and not limitation, computer-readable media may comprise computer storage media and communication media.

Computer storage media includes both volatile and nonvolatile, removable and non-removable media implemented in any method or technology for storage of information such as computer-readable instructions, data structures, program modules or other data.

Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information, and which can be accessed by computing device.

Communication media typically embodies computer-readable instructions, data structures, program modules or other data in a modulated data signal such as a carrier wave or other transport mechanism and includes any information delivery media. The term “modulated data signal” means a signal that has one or more or its characteristics set or changed in such a manner as to encode information in the signal.

By way or example, and not limitation, communication media includes wired media such as a wired network or direct-wired connection, and wireless media such as acoustic, RF, infrared and other wireless media. Combinations or any or the above should also be included within the scope of computer-readable media.

Memory includes computer-storage media in the form or volatile and/or nonvolatile memory. The memory may be removable, non-removable, or a combination thereof. Exemplary hardware devices include solid-state memory, hard drives, optical-disc drives, etc.

Computing device includes one or more processors that read data from various entities such as memory or I/O components. Presentation component(s) present data indications to a user or other device. Exemplary presentation components include a display device, speaker, printing component, vibrating component, etc.

I/O ports allow computing device to be logically coupled to other devices including I/O components, some of which may be built in. Illustrative components include a microphone, joystick, game pad, satellite dish, scanner, printer, wireless device, etc.

As previously mentioned, embodiments of the present invention may be implemented, at least in part, by a zoned 3D object in a 3D environment.

The device with the application using the zoned 3D object in a 3D environment may include components such as those described above with reference to FIG. 1 for the general computing device, including, for instance, memory, processors, computer-readable media, input/output components, and a power supply. The 3D object in the application may be provided in any of a number of different form factors, including, for instance, personal devices, gaming consoles, display panels, glasses, goggles, or a helmet.

Some devices applications may use the zoned 3D object to provide an augmented view of the real world to a user by augmenting the user's view of the real world with computer-generated virtual images. To provide the user with an augmented view, the device may include display technology that displays computer-generated virtual images while still allowing the user to view the real world.

In some devices, this may include applications in the rea world technology, which may employ, for instance, any type of projection or micro display technology to provide the virtual images. Other technologies may also be employed, such as retinal displays in which images are projected directly on the user's retina while the user is viewing the real world.

In some embodiments, the zoned 3D object in a 3D environment may align computer-generated virtual images with the zoned 3D object user's view of the real world as the user's view of the real-world changes.

To assist in locating virtual images in the user's view of the real world, the application's device may include devices that may monitor location and/or provide head, eye, and/or gaze tracking.

These devices may include, without limitation, GPS or other location tracking components, cameras or other optical sensors, gyroscopes, and accelerometers, to name a few.

The application's device may also include wireless communication capabilities to allow the zoned 3D object to communicate with companion devices (e.g., smartphones), server devices, or other network components. For instance, some embodiments of the present invention may be implemented by having a cloud-based service assist the application with zoned 3D objects in selecting virtual images to provide an augmented view or the real world. In some embodiments; the zoned 3D object may communicate with server devices via a companion device local to the zoned 3D object user (e.g., a smartphone or other device).

Vicinity Based Advertising on Zoned 3D object in a 3D Environment

Some embodiments or the present invention are directed to providing advertisements based on the person's current interests and thoughts by tracking the person's view of zones on a zoned 3D object to determine the person's attention. Instead of using data regarding objects within the 3D environment user's field or view, an object within the zoned 3D object user's actual zone viewing is determined and advertising information is provided based on the duration of the view. As is known in the art, a field or view includes the entire extent or what a person sees at a given moment.

In an application a zoned 3D object user's duration of view will also be tracked and employed for advertisement selection and display. The amount of time a zoned 3D object user's zone view remains in a particular zone on the object is indicative of different levels of interest in the advertisement being viewed. The longer a person gazes at a particular advertisement zone on the object, the more interest they have displayed in the advertisement the zoned 3D object user likely has in that advertisement and the stronger the data point becomes for advertisement re-targeting.

In some embodiments, a minimum threshold period of time may need to be satisfied before any advertising tracking is transmitted. For instance, a zoned 3D object in a 3D environment user may pan over a zone on a zoned 3D object focal point quickly moving from zone to zone. In such a situation, tracking data would only be submitted to the server once threshold on the advertisement has been fulfilled.

Additionally, since the zoned 3D object user is not focusing on any particular zone for more than a quick glance, the advertisement zones are not likely of particular interest to the user such that advertising zones on the object would not be particularly targeted. However, once an zoned 3D object user's focal point remains on a particular zone for the maximum threshold of time, advertising zone tracking data would begin to be transmitted to server for analytics.

In some instances, a zoned 3D object user may glance away from a zoned object and then return to the zoned object. The system may be able to recognize that the zoned 3D object user's interest has primarily remained on the object, and the system may ignore the glance away and treat the zone tracking as if the zoned 3D object user continued to view the object.

For instance, a zoned 3D object user may look at an advertisement for a restaurant and then view the advertisement or another restaurant. This information may indicate that that zoned 3D object user is looking for a place to eat or hungry. Based on this aggregate data, the system may select advertising information regarding other restaurants or food delivery in the next zoned 3D object user's vicinity and display the a targeted advertisement to the zoned 3D object user's.

Additional data signals may be used for advertisement selection in conjunction with an object within a zoned 3D object vicinity. By way or example only and not limitation, additional data signals that may be used may include the zoned 3D object user's biometrics or a user profile for the zoned 3D object user.

For instance, in some embodiments, a user profile may be maintained for the zoned 3D object user and used in conjunction with the zoned 3D object being viewed to select advertising information to display to the next zoned 3D object. The user profile may include a variety or information regarding the zoned 3D object user, such as the zoned 3D object user's demographics, preferences, and interests. For instance, suppose that zoned 3D object user is looking at a advertisement tor a restaurant and the zoned 3D object user's user profile includes a list of restaurants that the zoned 3D object user prefers.

Based on these data points, the system may determine that a preferred restaurant from the user profile is nearby in the real world or offers a convenient delivery service near the zoned 3D object user. As such, the system may deliver advertising information for that preferred restaurant to the zoned 3D object user, including the restaurant's location.

In various embodiments of the present invention, the object being viewed may be either a non-advertisement object or an advertisement. An advertisement may include anything which has the primary purpose of providing an advertising message.

For instance, advertisements could include billboards, press advertisements (e.g., in magazines, newspapers, etc.), and in-store advertisements, to name a few. In contrast, a non-advertisement object could be anything else that does not have advertising as its primary purpose.

For instance, the object could be something that could be purchased, such as clothing, electronic devices, etc. Additionally, the object could be a bar code or other machine-readable code. As another example, the object could be text read by the zoned 3D object user. Other objects, such as buildings and monuments, could also be non-advertisement objects that when viewed by a zoned 3D object user's focal point may trigger the display of advertising information via the user's zoned 3D object in the 3D environment.

Turning to FIG. 2, a flow diagram is provided that illustrates a method for injecting code into the 3d objects to enable vicinity and zone tracking. This code provides advertisements via the zoned 3D object in a 3D environment based on the vicinity of the zoned 3D object user's. The zoned 3D object in a 3D environment user's zone tracking data may be determined using any or a variety or techniques for eye and gaze tracking.

For instance, in one embodiment, the zoned 3D object application device may be equipped with outward-facing and inward-facing cameras. The outward-facing camera may be configured to capture the outside world around the zoned 3D object user. The inward-racing camera may be configured to track the zoned 3D object user's eyes to determine the line of gaze to each zone on the zoned 3D object. Using images/video from these cameras, the application's device may determine where in the outside world the zoned 3D object user's zone views were tracked to.

As another example, in another embodiment, the application user's zone views may be determined by capturing an image of the zoned 3D object user's retina. It should be understood that these are only examples and other techniques for determining the zoned 3D object in a user's zone views may be employed within embodiments or the present invention.

In some embodiments, a person may specify information regarding products he/she owns or services the person receives to facilitate the delivery of advertising information when the virtual 3d avatar is viewed by a zoned 3D object user. This could be viewed as a “word of mouth” approach of spreading information regarding products and services in that a zoned 3D object user may find out about products or services when viewing a virtual 3D avatar. In some embodiments, advertisers may provide incentives to a person if the person includes the advertisers' products or services in the list of products and services the person would like to share with others. For instance, an advertiser could provide rebates or other incentives for a person to simply include the advertiser's product or services in the person's list of products and services that may be viewed by zoned 3D object users when viewing the person. In other instances, the amount of rebates or other incentives may be based on the number of zoned 3D object users who are presented with information regarding the advertiser's product or service when viewing the person. In some cases, the amount or rebates or other incentives may be based on the number or zoned 3D object users who take further action alter viewing the advertising information, such as purchasing the advertiser's product or service. Any and all such variations are contemplated to be within the scope or embodiments or the present invention.

In some embodiments, a person is given the ability to also control access rights for zoned 3D object viewer to information associated with that person. This may include controlling which zoned 3D object user's is able to access information for that person or group.

Additionally, the person may be able to control what information different zoned 3D object user's are able to access and view for that person. The access rights could be based on, for instance, individuals specifically identified by the person, individuals included in the person's contact list, and/or individuals who have some relationship with the person, such as being affiliated (e.g., “friends”) in a social network.

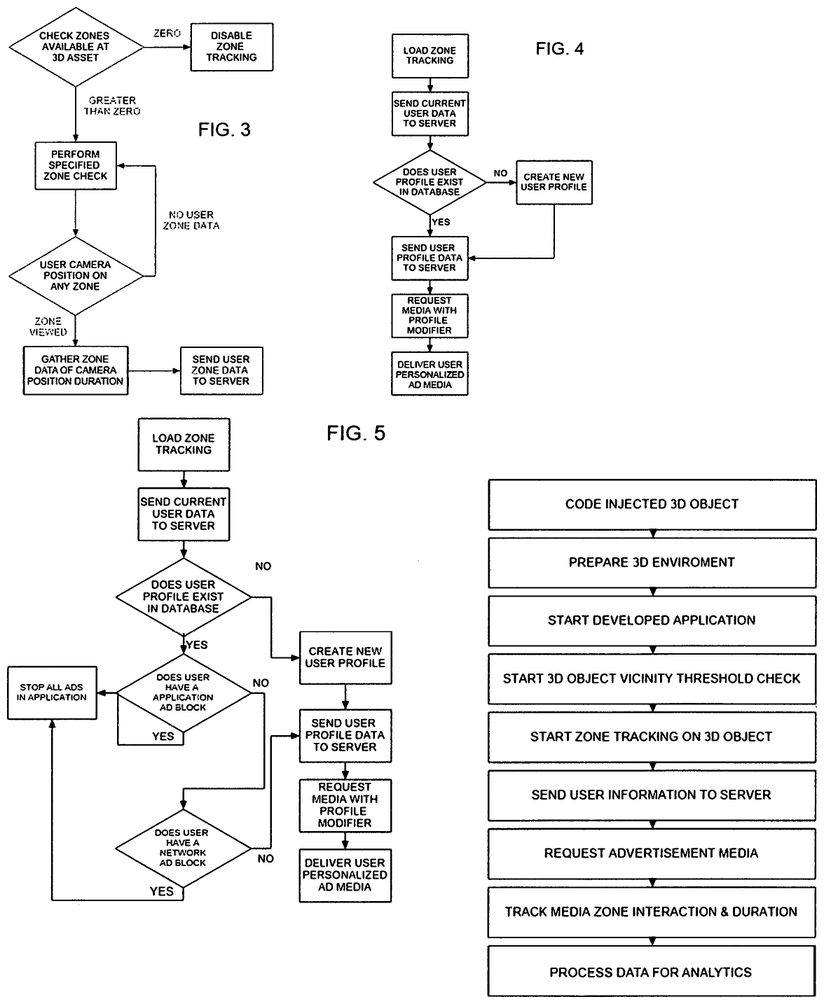

With reference now to FIG. 3, a flow diagram is provided that illustrates a method 3 for performing checks of zone tracking. Then gather zone data based on camera position on the zoned 3D object in a 3D environment.

In other embodiments, the zone tracking may allow zoned 3D object users to view the object or person at different times. For instance, the system could track what visitors to an art museum view over time to identify artwork and advertisements in the vicinity that is viewed more frequently by visitors. The identification of objects or people that are viewed by a threshold of zoned 3D object viewers may be employed in a number of different ways in various embodiments of the present invention.

In some embodiments, advertisement may be provided to an zoned 3D object user in the vicinity who is not viewing the object or person to draw that zoned 3D object user's attention to the object or person.

This may include animating the object or person to attract the zoned 3D object user's attention if the object or person is within the zoned 3D object user's vicinity in a 3D environment user's.

According to some embodiments, based on identifying a threshold of zoned 3D object user viewing an advertisement, the advertisement may be configured to perform some action. For instance, if the advertisement is an electronic billboard, the billboard's display may change in response to determining that the billboard is being viewed in one of the zones on the zoned 3D object.

Turning to FIG. 4, a flow diagram is provided that illustrates a method for personalizing the advertisements that are delivered to the zoned 3d object. User profiles would be uploaded to the server to determine past advertisement views, local or regional trends, demographics. Once this is determined the object would request the most relevant advertisement media from the server. At receipt the object will begin to play the content if the zoned 3D object user vicinity threshold is met.

Augmented View of Advertisements

Further embodiments of the present invention are directed to modifying or removing a zoned 3D object user's view of an advertisement. The advertisement may be any kind of advertisement displayed in the Virtual Environment or augmented Virtual real world.

By way of example only and not limitation, this could include billboards, press advertisements (e.g., in magazines, newspapers, etc.), in-store advertisements, and electronic advertisements, to name a few. The advertisement may have a generic message for people who are not utilizing the application with a zoned 3D object in the 3D environment. However, for user's application, the view of the advertisement may be augmented by the zoned 3D object in the 3D environment to provide a richer experience.

The view of an advertisement may be augmented in any number of different manners within the scope of embodiments of the present invention. For instance, in some embodiments, ents, an advertisement may be augmented to draw the zoned 3D object user's attention to the advertisement.

Augmenting a zoned 3D object user's view of an advertisement may include augmenting portions of the advertisement or re-skinning the entire advertisement in various embodiments of the present invention. Additionally, the augmented view may include, for instance, any combination of 2-dimensional images, 3-dimensional images, holographic, static images, or dynamic images.

Turning to FIG. 5, a flow diagram is provided that illustrates a method for removing advertisements from an application that employs zoned 3D objects in a 3d environment. Beginning with zone tracking the object would check the current user date for an existing profile. Once profile is found object will search for an Advertiser block in the application on said profile. If clear object will search for a Advertiser block on Advertisement provider network, if present all advertisement will be removed from zoned 3d objects.

Removing or Replacing Advertisements

Given the amount of advertising in today's world, some people may feel inundated with advertisements. To address this issue, in some embodiments, zoned 3D object in the 3D environment may augment the view of an advertisement to either remove the advertisement or replace the advertisement with other non-advertising content. As such, while other embodiments discussed above are directed to augmenting a zoned 3D object user's view of an advertisement to enhance the advertising message, the currently discussed embodiments are directed to removing the advertising message altogether from the zoned 3D object user's view.

As noted above, in some embodiments, advertisements may be removed from the zoned 3D object user's view. For instance, the zoned 3D object may augment the view of a billboard to make the billboard appear to be blank. However, the zoned 3D object viewer would still see the blank billboard.

Alternatively, the zoned 3D object in a 3D environment may augment the view of the billboard by making it appear that the billboard isn't there at all. The zoned 3D object or a server device in communication with the zoned 3D object may determine what computer-generated virtual images should be generated and displayed to present to the zoned 3D object user what is behind the advertisement to make it appear that the advertisement isn't there. By way of specific example, if the advertisement is a billboard on the side of a building, the virtual image may represent the side of the building to make the building appear without the billboard.

Alternatively, instead of removing an advertisement, the advertising content on the advertisement may be replaced with non-advertising content. In some instances, the non-advertising content may be the zoned 3D object user's own content. For instance, the content on a billboard could be replaced with an image from the zoned 3D object user's photo library. As such, instead of seeing billboards and other advertisements as the zoned 3D object user moves around the real world, the zoned 3D object user would see their own images where the advertisements are displayed. In other instances, the non-advertising content may be content not owned by the zoned 3D object user. For instance, a billboard could be replaced with images from places the zoned 3D object user has never been. When an advertisement is replaced with other content, the content shown may be static content, such as an image, or the content shown may be dynamic content, such as a video. For example, if the zoned 3D object user is a football fan, an advertisement could be replacement content may be 2-dimensional or 3-dimensional content.

The ability to remove or replace advertisements with other content may be a lee-based service provided to users or may be an option provided to users who are members of some service or group. For instance, the ability to remove or replace advertisements may be provided as an option to users who are LinkedIn members. Additionally, various levels of control may be given to users based on the fee paid or the membership level of the user (e.g., LinkedIn Basic members or LinkedIn Premium members). This may include, for instance, the ability to remove advertisements, the ability to replace advertisements with other content, the ability to control what content is used to replace advertisements, and the ability to control content or types of advertisements removed or replaced. Generally, a higher fee or membership level will provide greater control to the user.

1. One or more computer-storage media devices storing computer-useable instructions that, when used by one or more computing devices, cause the one or more computing devices to perform a method for a device with an application deploying a zoned 3D object in a 3D environment.

2. The one or more computer storage media devices of claim 1, wherein the augmented view of the real-world advertisement is provided when the zoned 3D object user's zone view is on the zoned 3d object in the virtual or real-world advertisement.

3. The one or more computer storage media devices of claim 2, wherein the method further comprises: initially determining that the zoned 3D object user's attention can be modified or augmented view or/the virtual or real-world advertisement to draw the zoned 3D object user's attention to the advertisement.

4. The one or more computer storage media devices or claim 3, wherein the augmented view or the virtual or real-world advertisement that is personalized on the zoned 3D object user comprises additional advertising information selected based on the content or the advertisement and the user profile information for the zoned 3D object user.

5. The one or more computer storage media devices of claim 1, wherein causing the zoned 3D object in a 3D environment applications' device to provide the augmented view of the virtual or real-world advertisement comprises: augmenting a portion of the virtual or real-world advertisement, or re-skinning the entire virtual or real-world advertisement.

6. The one or more computer storage media devices of claim 1, wherein a server device in communication with the zoned 3D object in a 3D environment applications' device determines how to augment the zoned 3D object user's view of the virtual or real-world advertisement based on the content of the advertisement and the user profile information for the zoned 3D object user.

7. The one or more computer storage media devices of claim 3, wherein the computer-generated virtual image is displayed within the zoned 3D object user's vicinity to replace the zoned 3D object user's view of the virtual and/or real-world advertisement with the non-advertising content when the zoned 3D object user's zone view is on the advertisement.

8. The one or more computer storage media devices of claim 3, wherein the non-advertising content comprises the zoned 3D object user's content.

9. The one or more computer storage media devices or claim 3, wherein the computer-generated virtual image is displayed within the zoned 3D object user's field or view to replace the zoned 3D object user's view or the virtual or real-world advertisement with the non-advertising content based on a Toe-based or membership-based service provided to the zoned 3D object user by application provider or advertisement provider.

10. The one or more computer storage media devices of claim 8, wherein a server device in communication with the zoned 3D object applications' device determines how to augment the zoned 3D object user's view or the virtual or real-world advertisement to replace the zoned 3D object user's view or the virtual or real-world advertisement with non-advertising content.
